(19) United States
(12) Patent Application Publication
(10) Pub. No.: US 2012/0271985 A1
(43) Pub. Date: Oct. 25, 2012

(54) SEMICONDUCTOR MEMORY SYSTEM SELECTIVELY STORING DATA IN NON-VOLATILE MEMORIES BASED ON DATA CHARACTERSTICS

(75) Inventors: Hyo-jin Jeong, Seongnam-si (KR); Young-joon Choi, Seongnam-si (KR); Jae-hyeon Ju, Seoul (KR)

(73) Assignee: SAMSUNG ELECTRONICS CO., LTD., SUWON-SI (KR)

(21) Appl. No.: 13/452,529

(22) Filed: Apr. 20, 2012

(30) Foreign Application Priority Data
Apr. 20, 2011 (KR) 10-2011-0036849

(51) Int. Cl. G06F 12/00; G06F 12/02

(52) U.S. Cl. 711/103; 711/154; 711/E12.001; 711/E12.008

(57) ABSTRACT

A semiconductor memory device includes a memory block and memory transmission and reception unit. The memory block includes a first non-volatile memory allocated to a first region having a first address range of physical addresses and a second non-volatile memory allocated to a second region having a second address range different from the first address range, which are mapped to logical addresses of a storing region in a host device. The memory transmission and reception unit performs data input and output operations between the host device and the first non-volatile memory using a first data input and output type, and performs data input and output operations between the host device and the second non-volatile memory using a second data input and output type. The first data input and output type performs the data input and output operations by access units corresponding to the first non-volatile memory.

### CROSS-REFERENCE TO RELATED APPLICATIONS

A claim of priority under 35 U.S.C. §119 is made to Korean Patent Application No. 10-2011-0036849, filed on Apr. 20, 2011, in the Korean Intellectual Property Office, the entire contents of which are hereby incorporated by reference.

### BACKGROUND

The inventive concept relates to semiconductor memory devices, and more particularly, to a semiconductor memory system optimized based on data characteristics by performing data transmission and reception together with a host device.

Semiconductor memory devices are typically classified as volatile memory devices or non-volatile memory devices. The volatile memory devices lose stored contents at power-off, while the nonvolatile memory devices retain stored contents even when power is removed or turned off. One type of non-volatile memory device is a NAND flash memory. NAND flash memories have general limitations on satisfying demand for high speed operations and low latency for random data transmissions because overwriting is not possible and programming is performed by page units.

### SUMMARY

The inventive concept provides a semiconductor memory system operating optimally based on characteristics of data to be stored. The inventive concept also provides methods of operating the semiconductor memory system.

According to an aspect of the inventive concept, there is provided a semiconductor memory system including a memory controller and a semiconductor memory device, which includes a memory block and memory transmission and reception unit. The memory block includes a first non-volatile memory allocated to a first region having a first address range of physical addresses and a second non-volatile memory allocated to a second region having a second address range of physical addresses different from the first address range, the first and second address ranges being mapped to logical addresses of a storing region in a host device. The memory transmission and reception unit is configured to perform data input and output operations between the host device and the first non-volatile memory using a first data input and output type, and to perform data input and output operations between the host device and the second non-volatile memory using a second data input and output type. Data to be stored in the memory device are selectively stored via the memory transmission and reception unit in one of the first non-volatile memory or the second non-volatile memory based on characteristics of the data.

According to another aspect of the inventive concept, there is provided a semiconductor memory device including a memory block and a memory transmission and reception unit. The memory block includes a first non-volatile memory allocated to a first region defined by a first address range within a range of physical addresses mapped to logical addresses of a storing region provided in an external processor, and a second non-volatile memory allocated in a second region defined by a second address range within the range of physical addresses, the second region being different from the first region. The memory transmission and reception unit performs data input and output operations between the external processor and the first non-volatile memory using a first data input and output type, and performs data input and output operations between the external processor and the second non-volatile memory using a second data input and output type. The first data input and output type includes performing the data input and output operations between the processor and the first non-volatile memory by an access unit for the first non-volatile memory.

According to another aspect of the inventive concept, there is provided a semiconductor memory device including a memory block and a memory transmission and reception unit. The memory block includes a first non-volatile memory configured to store data having first data characteristics and a second non-volatile memory configured to store data having second data characteristics different from the first data characteristics, the first and second non-volatile memories having difference ranges of physical addresses. The memory transmission and reception unit includes a first transmission and reception unit configured for exchanging the data having the first data characteristics between a host device and the first non-volatile memory using a first data input and output type, and a second transmission and reception unit configured for exchanging the data having the second data characteristics between the host device and the second non-volatile memory using a second data input and output type, wherein the first data input output type comprises a direct access method.

### BRIEF DESCRIPTION OF THE DRAWINGS

Illustrative embodiments of the inventive concept will be more clearly understood from the following detailed description taken in conjunction with the accompanying drawings, in which:

FIG. 1 is a block diagram of a computing system, according to an exemplary embodiment;

FIGS. 2A through 2D are block diagrams illustrating a first non-volatile memory of FIG. 1, according to exemplary embodiments;

FIG. 3 is a circuit diagram illustrating a structure of a cell of the first non-volatile memory of FIG. 2A, according to an exemplary embodiment;

FIG. 4 is a circuit diagram illustrating an example of a structure of a second non-volatile memory of FIG. 1, according to an exemplary embodiment;

FIGS. 5A through 5C are diagrams illustrating examples of cell distribution in the second non-volatile memory of FIG. 4, according to exemplary embodiments;

FIGS. 6A through 6D are block diagrams illustrating a second non-volatile memory of FIG. 1, according to exemplary embodiments;

FIGS. 7A and 7B are block diagrams illustrating non-volatile memories of FIG. 1, according to exemplary embodiments;

FIG. 8 is a block diagram illustrating an example of the computing system of FIG. 1, according to an exemplary embodiment;

FIGS. 9 through 14 are block diagrams illustrating various kinds of data which may be stored in the first non-volatile memory of FIG. 1, according to exemplary embodiments;

FIGS. 15 and 16 are block diagrams illustrating a computing system, according to other exemplary embodiments;

FIG. 17 is a block diagram illustrating a memory card, according to an exemplary embodiment; and

FIG. 18 is a diagram illustrating a solid state drive, according to an exemplary embodiment.

### DETAILED DESCRIPTION OF THE EMBODIMENTS

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. Also, the term “exemplary” is intended to refer to an example or illustration.

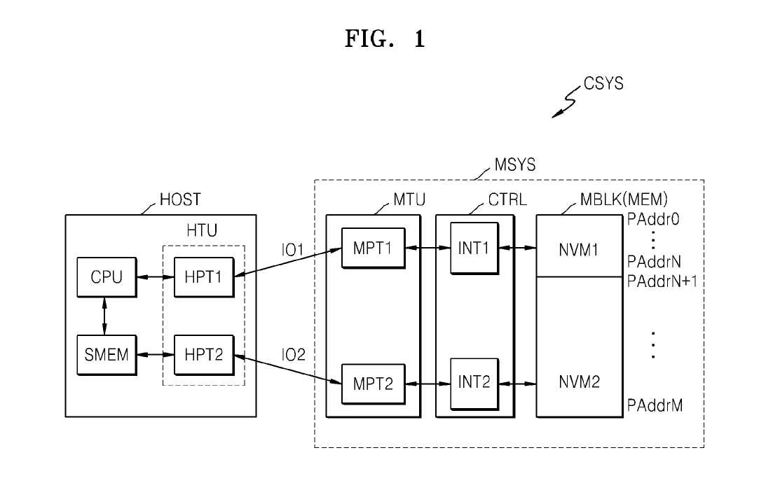

FIG. 1 is a block diagram of a computing system, according to an exemplary embodiment of the inventive concept.

Referring to FIG. 1, computing system CSYS includes a host device HOST and a semiconductor memory system MSYS. In performing an operation or application requested by a user, the host device HOST receives data from the semiconductor memory system MSYS and/or stores data in the semiconductor memory system MSYS. The host device HOST includes a processor CPU (e.g., a central processing unit) for processing the application requested by the user and a host transmission and reception unit HTU for performing data transmission and reception, together with the semiconductor memory system MSYS in response to the application. In addition, the host device HOST includes system memory SMEM as a storing region and for transmitting data to the semiconductor memory system MSYS or for storing data received from the semiconductor memory system MSYS.

The semiconductor memory system MSYS includes a semiconductor memory device MEM and a memory controller CTRL. The semiconductor memory device MEM includes one or more memory blocks, indicated by representative memory block MBLK, and memory transmission and reception unit MTU. The memory block MBLK is a data storing region. The memory transmission and reception unit MTU is configured to perform data transmission and reception together with the host device HOST. The memory controller CTRL is configured to interface between the memory transmission and reception unit MTU and the memory block MBLK, for controlling data writing to the memory block MBLK and data reading from the memory block MBLK.

The memory controller CTRL includes logic blocks for controlling the data writing to the memory block MBLK and the data reading from the memory block MBLK. For convenience of explanation, memory controller CTRL is shown as including only representative first and second interface units INT1 and INT2, which interface between the memory transmission and reception unit MTU and the memory block MBLK, of the logic blocks included in the memory controller CTRL.

According to an embodiment, the memory block MBLK includes first and second non-volatile memories NVM1 and NVM2, which are different kinds of memory. Each of the non-volatile memories NVM1 and NVM2 include physical addresses included within range PAddr0 through PAddrM of physical addresses of the memory block MBLK. The physical addresses of the memory block MBLK are mapped to logical addresses used in the host device HOST. More particularly, in the depicted embodiment, the first non-volatile memory NVM1 is allocated to a first region defined by first address range PAddr0 through PAddrN within the range PAddr0 through PAddrM of the physical addresses, and the second non-volatile memory NVM2 is allocated to a second region defined by second address range PAddrN+1 through PAddrM within the range PAddr0 through PAddrM of the physical addresses. Here, N and M are positive numbers, and M is larger than N. That is, in the example of FIG. 1, the first address range of the first region is from start address PAddr0 to finish address PAddrN, and second address range of the second region is from start address PAddrN+1 to a address PAddrM, where the start address PAddrN+1 of the second region is the next address following the finish address PAddrN of the first region.

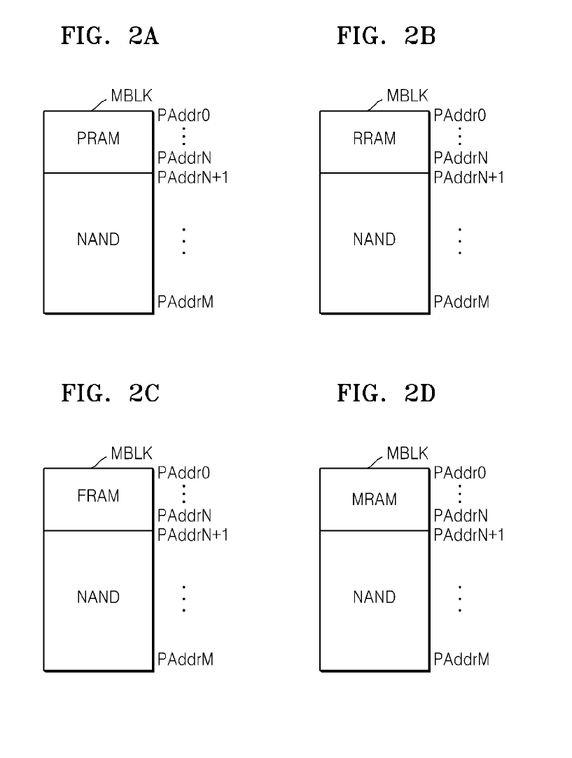

Data to be stored in the memory system MSYS are selectively stored in one of the first non-volatile memory NVM1 or the second non-volatile memory NVM2 based on characteristics of the data. For example, in an embodiment, the first non-volatile memory NVM1 is configured to store data relatively small in size and/or frequently accessed, while the second non-volatile memory NVM2 is configured to store data relatively large in size and/or occasionally or infrequently accessed. FIGS. 2A through 2D are block diagrams illustrating the first non-volatile memory NVM1 of FIG. 1, according to exemplary embodiments, where the second non-volatile memory NVM2 is illustratively a NAND flash memory.

Referring to FIG. 2A, the first non-volatile memory NVM1 is a phase-change random access memory (PRAM), for example. The PRAM is a non-volatile memory that stores data using phase change material, such as Ge—Sb—Te (GST), having a resistance that changes according to phase changes caused by changes in temperature.

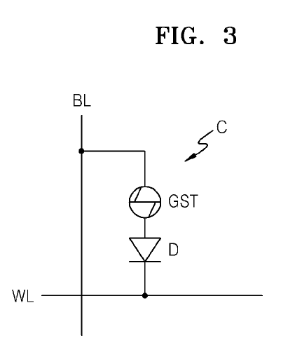

FIG. 3 is an equivalent circuit diagram of the PRAM depicted in FIG. 2A, according to an exemplary embodiment. Referring to FIG. 3, a unit cell C of the PRAM includes a single phase change material GST and a P—N diode D connected to the phase change material GST. The phase change material GST is connected to bit line BL and the P-terminal of the P—N diode D, and the N-terminal of the P—N diode D is connected to word line WL. The phase change material GST of the unit cell C stores information by crystallization or amorphization, according to temperature and/or heating time. Generally, a high temperature, e.g., above 900 degree Celsius, is necessary for a phase change of a phase change material GST, and may be obtained by Joule Heating using a current flowing in the unit cell C of the PRAM device, for example.

During a writing operation to the cell C of the PRAM device, when current flows in the phase change material GST, the state of the phase change material GST changes to one of a crystalline state or an amorphous state, depending on the amount of current flowing in the phase change material GST. For example, when the phase change material GST is rapidly cooled after being heated above its melting temperature by flowing a large current (“reset current”) in the phase change material GST for a short time, the phase change material GST enters the amorphous state, storing data “1.” This state is referred to as the reset state. When the phase change material GST is rapidly cooled after being heated above a crystallization temperature by flowing a small current (“set current”), less than the reset current, in the phase change material GST for a long time and maintaining the heated state for a predetermined time, the phase change material GST enters the crystalline state, storing data “0.” This state is referred to as the set state.

The cell C of the PRAM device is selected for a reading operation using the corresponding bit line BL and word line WL. The reading operation of the cell C discriminates data “1” from data “0” based on the difference in voltage change resulting from flowing current in the phase change material GST, the voltage change depending on the resistance value of the phase change material GST corresponding to the state. The resistance value of the phase change material GST in the reset state is larger than the resistance value of the phase change material GST in the set state.

The PRAM having the structure described above is a non-volatile memory, although the PRAM also has some characteristics of a dynamic random access memory (DRAM). For example, in the PRAM, data may be written and read by bytes, and thus fast random access may be performed. In addition, in the PRAM, it is possible to overwrite other data in a cell to which data is already written without first performing an erase operation.

FIGS. 2B through 2D depict other examples of the first non-volatile memory NVM1, which may be optimized for random access of small sized data. For example, as illustrated in FIG. 2B, the first non-volatile memory NVM1 of FIG. 1 may be a resistive random-access memory (RRAM). Alternatively, the first non-volatile memory NVM1 of FIG. 1 may be a ferroelectric random access memory (FRAM), as illustrated in FIG. 2C, or a magnetoresistive random access memory (MRAM), as illustrated in FIG. 2D.

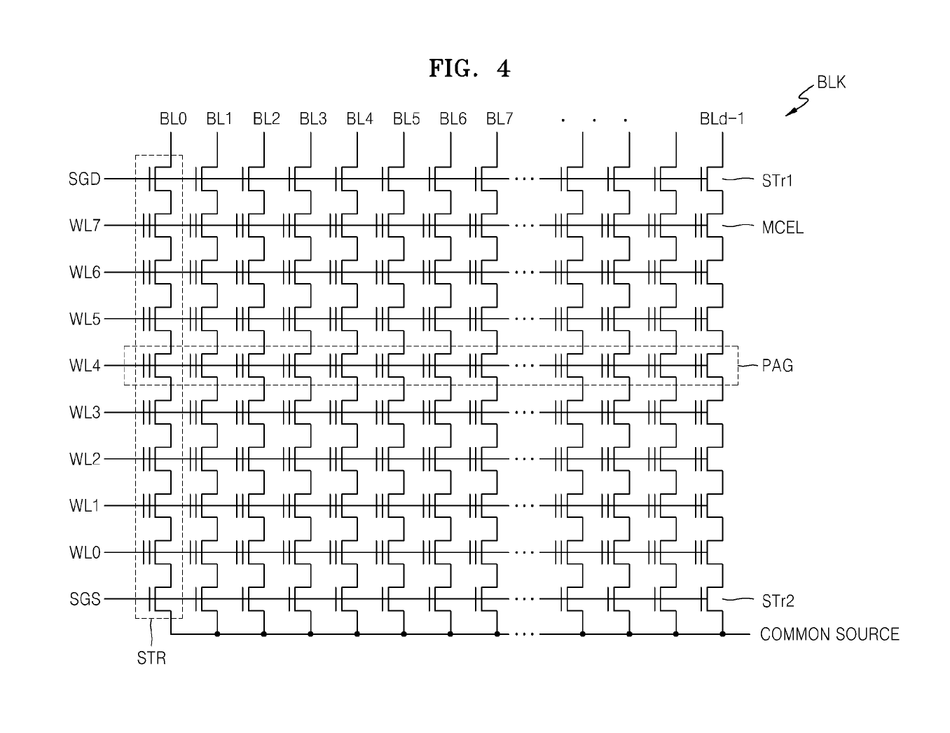

Referring again to FIG. 1, the second non-volatile memory NVM2 may be a flash memory, such as a NAND flash memory, as shown in FIGS. 2A through 2D. A memory cell array of the NAND flash memory may include multiple blocks BLK. FIG. 4 is a circuit diagram illustrating a representative block BLK, according to an exemplary embodiment. The block BLK of FIG. 4 includes multiple strings STR, each of which includes memory cells MCEL serially connected to each other in a direction of a bit line BLd-1. FIG. 4 illustrates an example in which eight memory cells MCEL are included in each string STR. However, according to various embodiments, the second non-volatile memory NVM2 may include strings having different numbers of memory cells (for example, 64 memory cells), without departing from the scope of the present teachings. Each of the strings STR include select transistors SGD and SGS connected respectively to end memory cells of the serially connected memory cells.

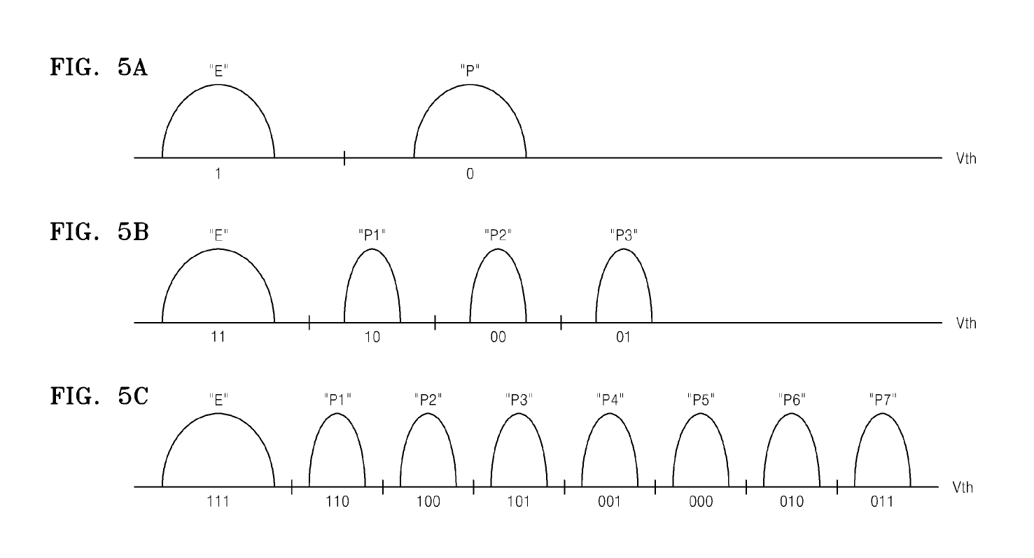

Depending on whether one or more bits of data are stored in each of the memory cells MCEL of the NAND flash memory of FIG. 4, the NAND flash memory may be a single-level cell (SLC) NAND flash memory or a multi-level cell (MLC) NAND flash memory, respectively. For example, memory cells of an SLC flash memory may have a cell distribution as shown in FIG. 5A, and memory cells of an MLC flash memory may have a cell distribution as shown in FIG. 5B or FIG. 5C. More particularly, FIG. 5B illustrates a cell distribution of a 2-bit MLC flash memory in which two bits are stored in each memory cell, and FIG. 5C illustrates a cell distribution of a 3-bit MLC flash memory in which three bits are stored in each memory cell.

In the case of FIG. 5A, the memory cell has one of two states, the erase state “E” and the program state “P.” In comparison, in the case of FIG. 5B, the memory cell may have one of four states, including one erase state “E” and three program states “P1,” “P2” and “P3.” In addition, in the case of FIG. 5C, the memory cell may have one of eight states, including one erase state “E” and eight program states “P1” through “P7”. In various embodiments, when programming is performed in accordance with FIGS. 5A through 5C, a Gray code is used for mapping each of the program states. The Gray code sets each of the program states to have only one bit difference from adjacent program states. However, the second non-volatile memory NVM2 of FIG. 1 may use different mapping methods than the Gray code and/or may store a different number of bits from those of FIGS. 5A through 5C in each memory cell, without departing from the scope of the present teachings.

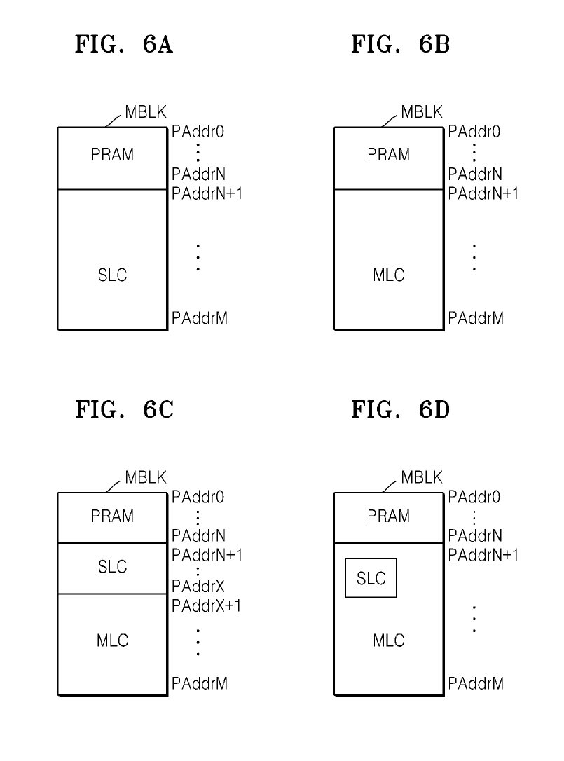

FIGS. 6A through 6D are block diagrams illustrating the second non-volatile memory NVM2 of FIG. 1, according to exemplary embodiments. In various embodiments, the second non-volatile memory NVM2 of FIG. 1 may include an SLC NAND flash memory as illustrated in FIG. 6A or an MLC NAND flash memory as illustrated in FIG. 6B, for example. Alternatively, the second non-volatile memory NVM2 of FIG. 1 may include a combination of an SLC NAND flash memory and an MLC NAND flash memory as illustrated in FIG. 6C. Or, the second non-volatile memory NVM2 of FIG. 1 may include an MLC NAND flash memory and, in a specific mode, may operate as an SLC NAND flash memory in which only one bit is stored in each memory cell, as illustrated in FIG. 6D.

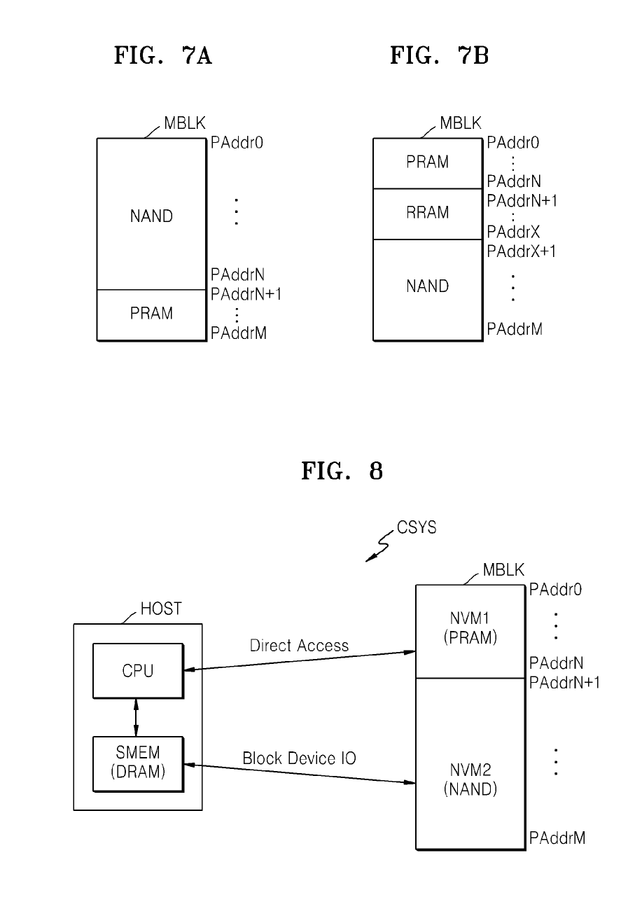

Various forms of the first non-volatile memory NVM1 in the first region, having the first address range PAddr0 through PAddrN, and various forms of the second non-volatile memory NVM2 in the second region, having the second address range PAddrN+1 through PAddrM, have been discussed above. However, the first non-volatile memory NVM1 and the second non-volatile memory NVM2 according to various embodiments may have different forms from the examples described above, without departing from the scope of the present teachings. For example, FIGS. 7A and 7B are block diagrams illustrating first and second non-volatile memories of FIG. 1, according to exemplary embodiments.

Referring to FIG. 7A, the second non-volatile memory NVM2 (e.g., a NAND flash memory) may be located in the first region, having the first address range PAddr0 through PAddrN, and the first non-volatile memory NVM1 (e.g., a PRAM) may be located in the second region, having the second address range PAddrN+1 through PAddrM. Alternatively, referring to FIG. 7B, the first non-volatile memory NVM1 may include multiple non-volatile memories of different types, such as non-volatile memories PRAM and RRAM. In this configuration, the first non-volatile memory NVM1 includes a PRAM located in a first region, having a first address range PAddr0 through PAddrN, a RRAM located in a second region, having a second address range PAddrN+1 through PAddrX, and a second non-volatile memory NVM2 (e.g., a NAND flash memory) located in a third second region, having a third address range PAddrX+1 through PAddrM.

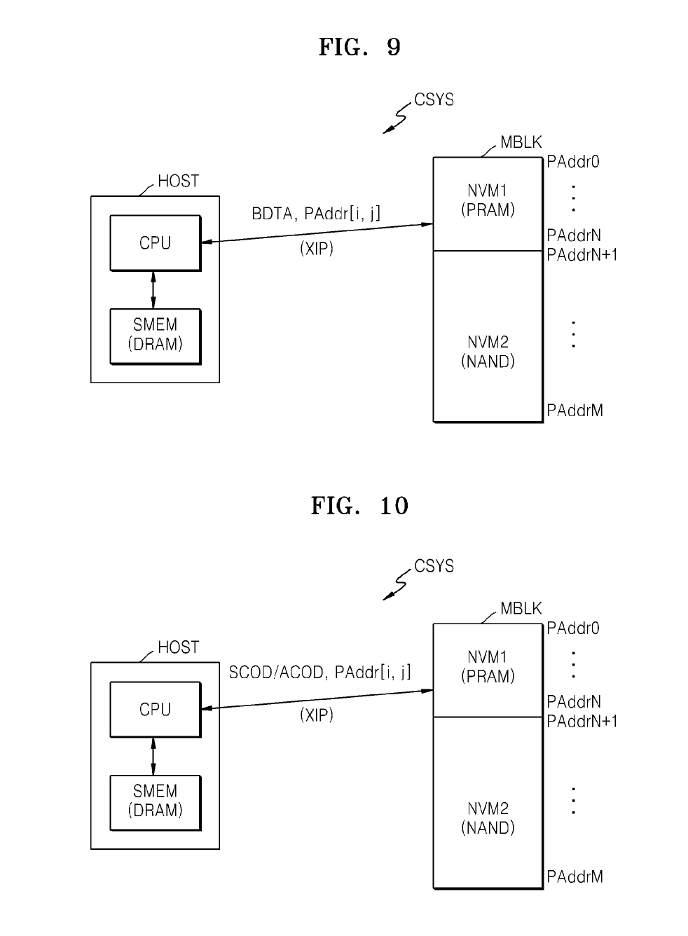

FIG. 8 is a block diagram illustrating an example of the computing system of FIG. 1, according to an exemplary embodiment. For convenience of explanation, FIG. 8 depicts the case in which the first non-volatile memory NVM1 is a PRAM formed in a region having a corresponding address range with a start address PAddr0 of the physical addresses and the second non-volatile memory NVM2 is a NAND flash memory formed in a region having a corresponding address range with a start address PAddrN+1, which is next to the last address PAddrN of the region in which the PRAM is formed. The structures and/or operations of the computing system CSYS or semiconductor memory system discussed below may apply to the examples of FIGS. 2A-2D, 6A-6D and 7A-7B, and the like, in which the first and second non-volatile memories NVM1 and NVM2 may have different forms from those of the first and second non-volatile memories NVM1 and NVM2 of FIG. 8, for example.

Referring to FIG. 8, in the computing system CSYS, the first non-volatile memory NVM1 performs data input and output operations together with the processor CPU of the host device HOST. That is, the processor CPU of the host device HOST may access the first non-volatile memory NVM1, which is a PRAM, by byte units. In this manner, when the host device HOST randomly accesses a memory by byte or word units, data such as programs or codes may be directly executed in the memory. Directly executing programs or codes in the memory is referred to as execute in place (XIP) or as a direct access method. According to direct access methods, there is no need to load data into a separate system memory when a host device accesses a memory. Therefore, the host device HOST may perform data transmission and reception together with the first non-volatile memory NVM1 without loading corresponding data into its separate system memory SMEM to access the first non-volatile memory NVM1. The system memory SMEM included in the host device HOST is a DRAM, although the system memory SMEM may be other types of memory, such as a static random access memory (SRAM), which may be accessed by byte units.

In the computing system CSYS according to the present embodiment of the inventive concept, the first non-volatile memory NVM1 interfaces with the host device HOST using a direct access method, such as XIP, while the second non-volatile memory NVM2 performs data transmission and reception together with the processor CPU using the system memory SMEM of the host device HOST. The processor CPU of the host device HOST recognizes the second non-volatile memory NVM2, which is a NAND flash memory, as a block device, and performs data transmission and reception together with the second non-volatile memory NVM2 by units corresponding to blocks of a file system of the host device HOST, referred to as Block Device IO in FIG. 8. Because the data input and output unit in the Block Device IO method is different from that of the second non-volatile memory NVM2, the system memory SMEM may perform a cache function, such that data is loaded into the system memory SMEM before being transmitted to the second non-volatile memory NVM2 and/or before being received from the second non-volatile memory NVM2.

The computing system CSYS or the semiconductor memory system MSYS according to an embodiment of the inventive concept may operate so that data relatively small in size and accessed frequently are stored in the first non-volatile memory NVM1 (e.g., a PRAM), and the first non-volatile memory NVM1 performs data input and output operations directly (direct access) together with the processor CPU of the host device HOST. In addition, the computing system CSYS or the semiconductor memory system MSYS may operate so that data relatively large in size and not frequently accessed are stored in the second non-volatile memory NVM2, and the second non-volatile memory NVM2 performs data input and output operations together with the processor CPU of the host device HOST using the system memory SMEM. That is, the computing system CSYS or the semiconductor memory system MSYS stores data in the first non-volatile memory NVM1 or the second non-volatile memory NVM2 so as to be optimized according to the characteristics of the data.

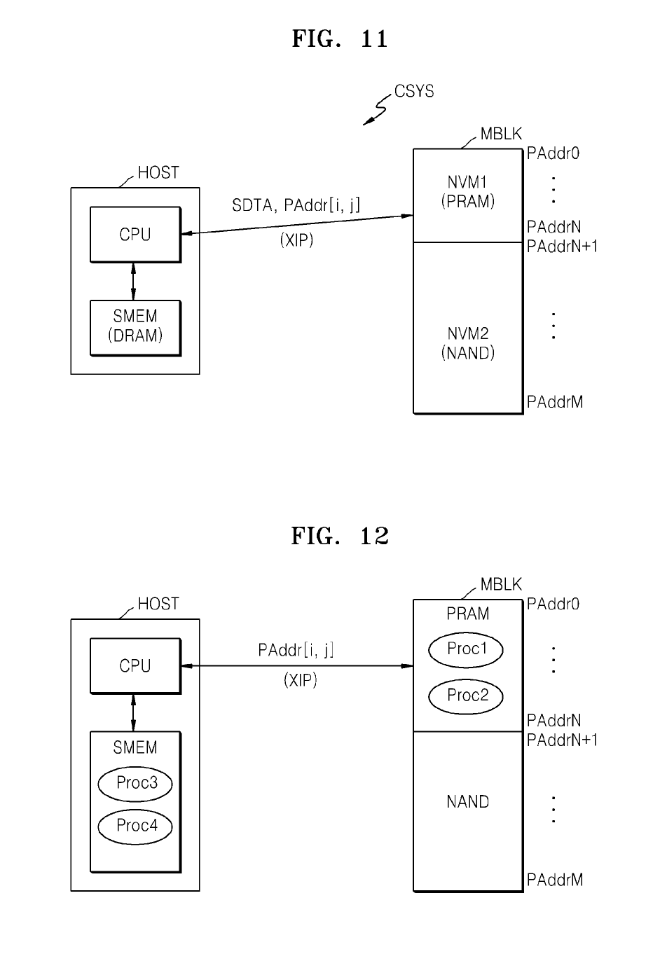

FIGS. 9 through 14 are block diagrams illustrating various kinds of data stored in the first non-volatile memory of FIG. 1, according to exemplary embodiments of the inventive concept.

Referring to FIG. 9, the computing system CSYS or the semiconductor memory system MSYS according to an embodiment of the inventive concept may store boot data BDTA of the host device HOST in the first non-volatile memory NVM1. Characteristics of the boot data BDTA are that the boot data BDTA is updated randomly by small units. As shown in FIG. 9, the processor CPU of the host device HOST may store the boot data BDTA to portion PAddr[i:j] of the first non-volatile memory NVM1, which is located in the first address range PAddr0 through PAddrN within the range PAddr0 through PAddrM of the physical addresses of the memory block MBLK. The processor CPU may perform direct access, using XIP, for example, on the portion PAddr[i:j] with corresponding addresses. Because the processor CPU of the host device HOST directly accesses the first non-volatile memory NVM1, which is a PRAM on which data writing and reading is performed by byte units, the computing system CSYS may perform a booting operation when the boot data BDTA is stored in the first non-volatile memory NVM1 without loading the boot data BDTA to the system memory SMEM of the host device HOST (XIP operation).

Referring to FIG. 10, the computing system CSYS or the semiconductor memory system MSYS according to an embodiment of the inventive concept may store system code SCOD of the host device HOST or application code ACOD, which is executed or is to be executed in the host device HOST, in the first non-volatile memory NVM1. Characteristics of the system code SCOD and the application code ACOD are that they are randomly updated by small units. The processor CPU of the host device HOST may store the system code SCOD or the application code ACOD to a portion PAddr[i:j] of the first non-volatile memory NVM1, which is located in the first address range PAddr0 through PAddrN within the range PAddr0 through PAddrM of the physical addresses of the memory block MBLK, and may perform direct access on the portion PAddr[i:j]. Because the processor CPU of the host device HOST directly accesses the first non-volatile memory NVM1, which is a PRAM on which data writing and reading is performed by byte units, the computing system CSYS may perform a corresponding operation when the system code SCOD or the application code ACOD is stored in the first non-volatile memory NVM1, without loading the system code SCOD or the application code ACOD to the system memory SMEM of the host device HOST (XIP operation).

Referring to FIG. 11, the computing system CSYS or the semiconductor memory system MSYS according to an embodiment of the inventive concept may store a process. For example, data SDTA, which is not executed for a predetermined time in the host device HOST, may be swapped so as to be stored in a virtual memory space, and re-executed by a request of a user, in the first non-volatile memory NVM1. A characteristic of the swap data SDTA is that the swap data SDTA is provided to the processor CPU of the host device HOST at high speed. The processor CPU may store the swap data SDTA to a portion PAddr[i:j] of the first non-volatile memory NVM1, which is located in the first address range PAddr0 through PAddrN within the range PAddr0 through PAddrM of the physical addresses of the memory block MBLK, and may perform direct access on the portion PAddr[i:j]. Because the processor CPU of the host device HOST directly accesses the first non-volatile memory NVM1, which may be a PRAM on which data writing and reading is performed by byte units, the computing system CSYS may perform a swap operation when the swap data SDTA is stored in the first non-volatile memory NVM1, without loading the swap data SDTA to the system memory SMEM of the host device HOST (XIP operation).

As illustrated in FIG. 12, the computing system CSYS or the semiconductor memory system MSYS according to an embodiment of the inventive concept may use the first non-volatile memory NVM1 as a virtual memory. For example, when a first process Proc1 or a second process Proc2 is stored in the system memory SMEM, and space of the system memory SMEM is insufficient to additionally store a third process Proc3 or a fourth process Proc4 loaded into the system memory SMEM, the computing system CSYS or the semiconductor memory system MSYS may store the first process Proc1 or the second process Proc2 in the first non-volatile memory NVM1, which may be a PRAM. In addition, when an access request for the first process Proc1 or the second process Proc2 occurs again, the processor CPU of the host device HOST may directly access the first non-volatile memory NVM1. Thus, the first non-volatile memory NVM1 may be used as a virtual memory.

Referring to FIG. 13, the computing system CSYS or the semiconductor memory system MSYS according to an embodiment of the inventive concept may store meta data FMDTA of a file system of the host device HOST in the first non-volatile memory NVM1. The meta data FMDTA stores mapping information between logic addresses used in the host device HOST and the physical addresses of the memory block MBLK. A characteristic of the meta data FMDTA of the file system is that the meta data FMDTA is randomly updated by small units, that is, by byte units. The processor CPU of the host device HOST may store the meta data FMDTA of the file system to a portion PAddr[i:j] of the first non-volatile memory NVM1, which is located in the first address range PAddr0 through PAddrN within the range PAddr0 through PAddrM of the physical addresses of the memory block MBLK, and may perform direct access on the portion PAddr[i:j]. Because the processor CPU of the host device HOST directly accesses the first non-volatile memory NVM1, which is a PRAM on which data writing and reading is performed by byte units, the computing system CSYS may perform a mapping operation of the file system when the meta data FMDTA of the file system is stored in the first non-volatile memory NVM1 without loading the meta data FMDTA of the file system to the system memory SMEM of the host device HOST (XIP operation).

In the above examples, user data, which is relatively large and not frequently accessed, is stored in the second non-volatile memory NVM2, which may be a NAND flash memory, for example. The second non-volatile memory NVM2 may perform the data input and output operations together with the processor CPU of the host device HOST using the system memory SMEM of the host device HOST. In this manner, the computing system CSYS or the semiconductor memory system MSYS according to embodiments of the inventive concept operate optimally with respect to the characteristics of the data by including different kinds of non-volatile memories in the range of physical addresses used for an access process in the host device HOST.

In the examples above, system data for the host device HOST is stored in the first non-volatile memory NVM1. FIG. 14 is a block diagram illustrating an example in which meta data for the second non-volatile memory NVM2 of the memory block MBLK is stored in the first non-volatile memory NVM1, according to an exemplary embodiment.

Referring to FIG. 14, the computing system CSYS or the semiconductor memory system MSYS according to an embodiment of the inventive concept stores meta data FTLMD, which is used in a flash translate layer (FTL) for mapping virtual addresses used in the host device HOST into physical addresses of a NAND flash memory, in the first non-volatile memory NVM1. Characteristics of the meta data FTLMD of the FTL are that the meta data FTLMD is randomly updated by small units. Mapping information for the NAND flash memory is frequently changed since the programming and erasing units are different from each other and overwriting is impossible. Therefore, the mapping information may be stored in a non-volatile memory for a sudden power-off. Unexpected latency may occur due to the characteristics of the NAND flash memory.

The processor CPU of the host device HOST according to an embodiment of the inventive concept may store the meta data FTLMD of the FTL to a portion PAddr[i:j] of the first non-volatile memory NVM1, which is located in the first address range PAddr0 through PAddrN within the range PAddr0 through PAddrM of the physical addresses of the memory block MBLK, and may perform direct access on the portion PAddr[i:j]. Because the processor CPU of the host device HOST directly accesses the first non-volatile memory NVM1, which is a PRAM on which data writing and reading is performed by byte units, the computing system CSYS may perform a mapping operation between the virtual addresses in the FTL and the physical addresses of the NAND flash memory when the meta data FTLMD of the FTL is stored in the first non-volatile memory NVM1, without loading the meta data FTLMD of the FTL to the system memory SMEM of the host device HOST (XIP operation).

Accordingly, the computing system CSYS or the semiconductor memory system MSYS according to an embodiment of the inventive concept may reduce latency, which would otherwise occur as a result of updating the frequently changed mapping information of the NAND flash memory.

Referring again to FIG. 1, the memory transmission and reception unit MTU of the semiconductor memory system MSYS may include first and second transmission and reception units MPT1 and MPT2, according to an exemplary embodiment of the inventive concept. The first transmission and reception unit MPT1 is configured for exchanging data between the host device HOST and the first non-volatile memory NVM1 using a first data input and output type IO1, and the second transmission and reception unit MPT2 is configured for exchanging data between the host device HOST and the second non-volatile memory NVM2 using a second data input and output type IO2. Likewise, the host transmission and reception unit HTU of the host device HOST includes first and second transmission and reception units HPT1 and HPT2 for performing data transmission and reception together with the memory transmission and reception unit MTU of the semiconductor memory system MSYS. The first transmission and reception unit HPT1 and the second transmission and reception unit HPT2 are connected to the first transmission and reception unit MPT1 and the second transmission and reception unit MPT2 of the memory transmission and reception unit MTU, respectively.

As described above, the first data input and output type IO1 may be a direct access method and the second data input and output type IO2 may be a block device input and output type different from the first data input and output type IO1, for example. In addition, when the first non-volatile memory NVM1 is a PRAM and the second non-volatile memory NVM2 is a NAND flash memory, for example, the first data input and output type IO1 includes transmitting and receiving data by byte units, and the second data input and output type IO2 includes transmitting and receiving data by block units, e.g., 4 kilobyte units.

The memory transmission and reception unit MTU of FIG. 1 may include a unified protocol (UniPro) layer or an M-PHY layer according to the Mobile Industry Processor Interface (MIPI) standard, as a physical layer. When converting data transmitted to the host device HOST or received from the host device HOST by the UniPro layer or the M-PHY layer, the memory transmission and reception unit MTU may support separate ports for logic units (for example, NVM1 and NVM2 of FIG. 1 and the like) mapped in the range of the physical addresses of the memory, respectively. The memory transmission and reception unit MTU of FIG. 1 may further include at least one layer for performing data minoring between the host device HOST and the semiconductor memory system MSYS together with the MIPI M-PHY layer.

As mentioned above, the memory controller CTRL of the semiconductor memory system MSYS of FIG. 1 includes the first and second interface units INT1 and INT2. The first interface unit INT1 is connected to the first transmission and reception unit MPT1 and performs as an interface so that the first non-volatile memory NVM1 may operate as an XIP device. The second interface unit INT2 is connected to the second transmission and reception unit MPT2 and performs as an interface so that the second non-volatile memory NVM2 may operate as a block device. As stated above, the block device refers to a device accessed through a file system using a block device input and output type together with the host device HOST.

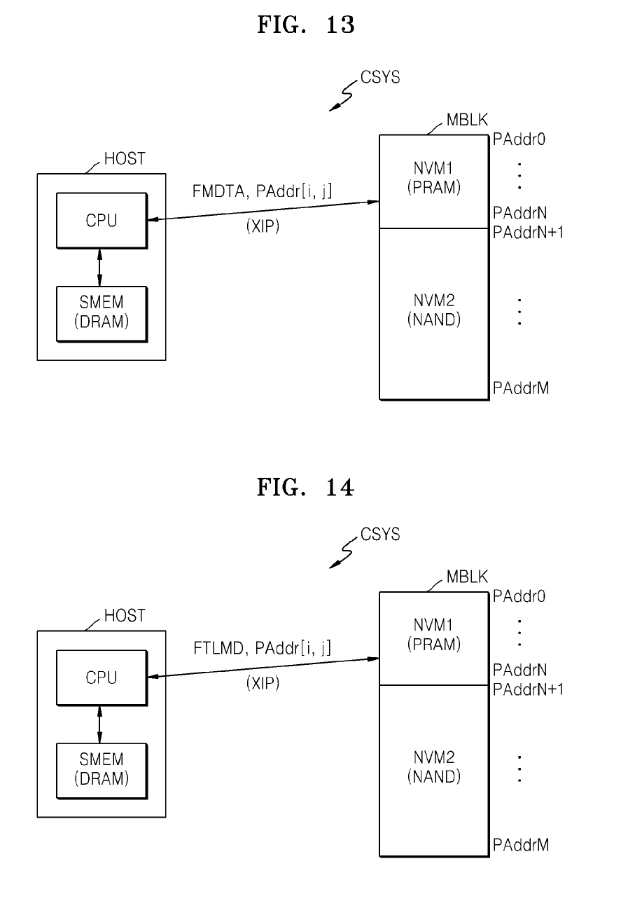

In the examples described above, only the first non-volatile memory NVM1 is directly accessed from the processor CPU of the host device HOST. However, the inventive concept is not limited to this configuration. For example, FIG. 15 is a block diagram illustrating the computing system CSYS, according to another exemplary embodiment of the inventive concept, in which the first transmission and reception unit MPT1 of the semiconductor memory system MSYS, which controls an interface of the non-volatile memory NVM1, also transmits and receives data using the second data input and output type IO2 together with the second transmission and reception unit HPT2 of the host device HOST. That is, the first non-volatile memory NVM1 may store user data and the like, as well as data accessed directly from the processor CPU of the host device HOST.

FIG. 16 is a block diagram illustrating a computing system CSYS, according to another exemplary embodiment of the inventive concept.

Referring to FIG. 16, in the computing system CSYS, a system memory RAM, and a semiconductor memory system MSYS are electrically connected via bus BUS. The semiconductor memory system MSYS includes a memory controller CTRL and a semiconductor memory device MEM. N-bit data (where N is a positive number equal to or greater than one) processed or to be processed by the processor CPU is stored in the semiconductor memory device MEM. The semiconductor memory system MSYS of FIG. 16 may be the same as the semiconductor memory system MSYS of FIG. 1 or FIG. 15. In addition, the computing system CSYS of FIG. 16 may further include a user interface UI and a power supply PS which are electrically connected via the bus BUS.

When the computing system CSYS according to the various embodiments is a mobile device, the computing system CSYS further includes a battery for supplying operation voltage to the computing system CSYS and a modem, such as a baseband chipset. In addition, a camera image processor (CIS), a mobile dynamic random access memory, and the like may be further provided in the computing system CSYS according to an embodiments of the inventive concept.

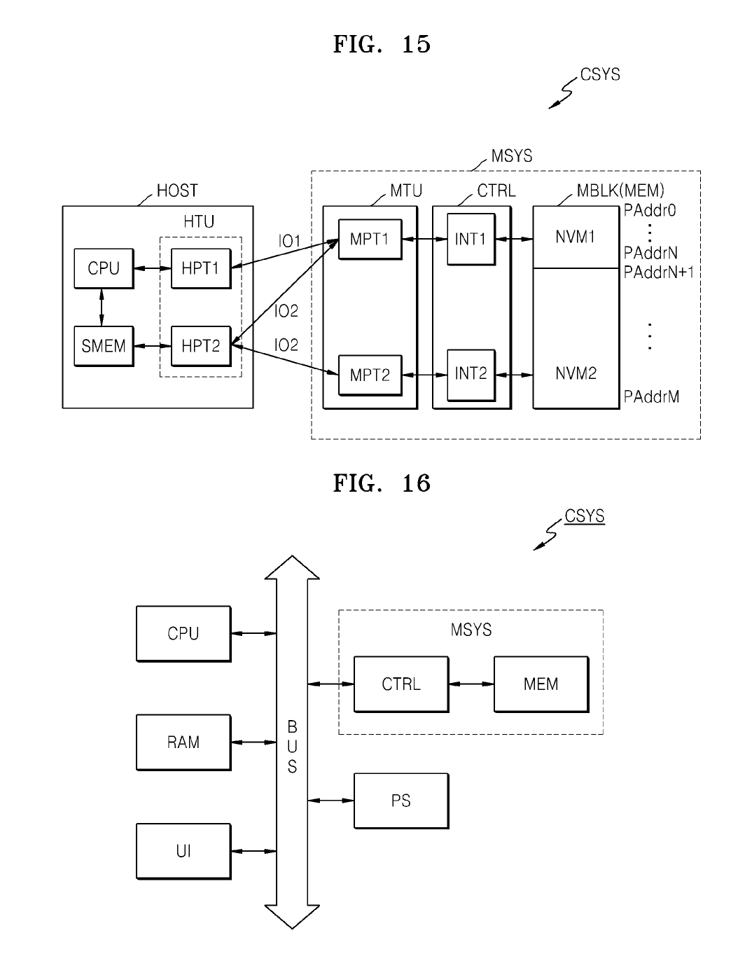

FIG. 17 is a block diagram illustrating a memory card MCRD, according to an embodiment of the inventive concept.

Referring to FIG. 17, the memory card MCRD includes a memory controller CTRL and a memory device MEM. The memory controller CTRL controls data writing to the memory device MEM and/or data reading from the memory device MEM in response to requests received through input and output unit I/O from an external host device (not shown). In addition, when the memory device MEM of FIG. 17 is a flash memory device, the memory controller CTRL controls erasing operations of the memory device MEM. The memory controller CTRL of the memory card MCRD may include interface units (not shown) for interfacing with the external host device and the memory device MEM respectively, and a random access memory (RAM) (not shown) to perform control operations.

In various embodiments, the memory controller CTRL of the memory card MCRD may be the same as the memory controller CTRL of FIGS. 1, 15 and 16, discussed above. Likewise, the memory device MEM of the memory card MCRD may be the same as the memory device MEM of FIGS. 1, 15 and 16. The memory card MCRD of FIG. 17 may be embodied in a compact flash card (CFC), a microdrive, a smart media card (SMC), a multimedia card (MMC), a security digital card (SDC), a memory stick, or a universal serial bus (USB) flash memory driver, for example.

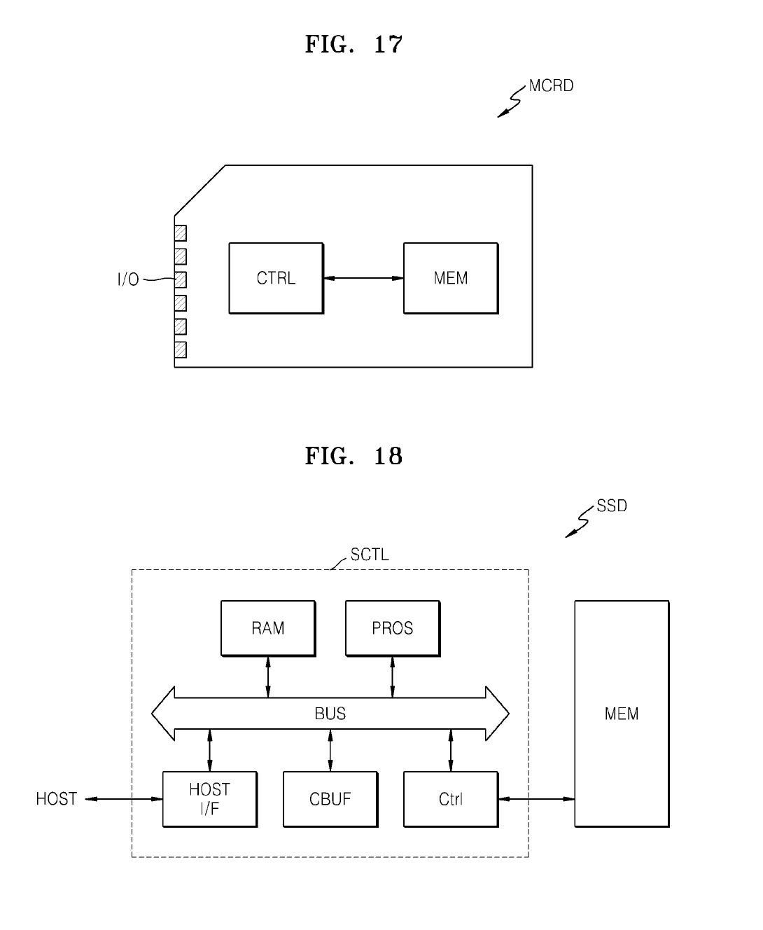

FIG. 18 is a block diagram illustrating a solid state drive SSD, according to an embodiment of the inventive concept.

Referring to FIG. 18, the solid state drive SSD according to the present embodiment includes a solid state drive controller SCTL and a memory device MEM. The solid state drive controller SCTL includes a processor PROS, a random access memory RAM, a cache buffer CBUF, and a memory controller CTRL, which are connected to each other via a bus BUS. The processor PROS controls the memory controller CTRL to exchange data with the memory device MEM in response to requests (e.g., commands, addresses, and data) of an external host (not shown). The processor PROS and the memory controller CTRL of the solid state drive SSD may be embodied in a single advanced reduced instruction set computer machine (ARM) processor, for example. Data required for operations of the processor PROS may be loaded to the access memory RAM.

A host interface HOST I/F receives the requests from the external host and transmits the requests to the processor PROS, or transmits data received from the memory device MEM to the host. The host interface HOST I/F may interface with the host using various interface protocols, such as universal serial bus (USB), man machine communication (MMC), peripheral component interconnect-express (PCI-E), serial advanced technology attachment (SATA), parallel advanced technology attachment (PATA), small computer system interface (SCSI), enhanced small device interface (ESDI), intelligent drive electronics (IDE), or the like. Data to be transmitted to the memory device MEM or data transmitted from the memory device MEM may be temporarily stored in the cache buffer CBUF. The cache buffer CBUF may be a static random access memory SRAM or the like.

In various embodiments, the memory controller CTRL and the memory device MEM included in the solid state drive SSD may be the memory controller CTRL and the memory device MEM may be the same as the memory device MEM and the memory controller CTRL of FIGS. 1, 15 and 16, respectively.

The semiconductor memory device according to embodiments of the inventive concept may be packaged using various types of packages. For example, the semiconductor memory device may be packaged using a package on package (POP), a ball grid array (BGA), a chip scale package (CSP), a plastic leaded chip carrier (PLCC), a plastic dual in-line package (PDIP), a die in waffle pack (DWP), a die in wafer form (DWF), a chip on board (COB), a ceramic dual in-line package (CERDIP), a plastic metric quad flat pack (MQFP), a thin quad flat pack (TQFP), a small outline (SOIC), a shrink small outline package (SSOP), a thin small outline (TSOP), a thin quad flat pack (TQFP), a system in package (SIP), a multi-chip package (MCP), a wafer-level fabricated package (WFP), a wafer-level processed stack package (WSP), or the like.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

For example, when the second non-volatile memory NVM2 performs both functions of the SLC NAND flash memory and the MLC NAND flash memory, as described with reference to FIG. 6C and FIG. 6D, data among the user data that should be accessed at high speed with relatively small delay may be stored in the SLC NAND flash memory, and data among the user data that is relatively large and is not frequently accessed may be stored in the MLC NAND flash memory. In addition, the computing system CSYS, the semiconductor memory system MSYS, or the semiconductor memory device MEM are not limited to the examples of FIGS. 9 through 14, and the host or a user may set data stored in the first non-volatile memory NVM1.

What is claimed is:

1. A semiconductor memory system comprising:
a memory controller; and
a semiconductor memory device, comprising:
a memory block including a first non-volatile memory allocated to a first region having a first address range of physical addresses and a second non-volatile memory allocated to a second region having a second address range of physical addresses different from the first address range, the first and second address ranges being mapped to logical addresses of a storing region in a host device; and
a memory transmission and reception unit for performing data input and output operations between the host device and the first non-volatile memory using a first data input and output type, and performing data input and output operations between the host device and the second non-volatile memory using a second data input and output type,
wherein data to be stored in the memory device are selectively stored via the memory transmission and reception unit in one of the first non-volatile memory or the second non-volatile memory based on characteristics of the data.

2. The semiconductor memory system of claim 1, wherein the first data input and output type performs the data input and output operations between the host device and the first non-volatile memory by access units corresponding to the first non-volatile memory.

3. The semiconductor memory system of claim 2, wherein the first data input and output type includes an execute-in-place (XIP) method.

4. The semiconductor memory system of claim 3, wherein the second data input and output type includes a block device input and output type.

5. The semiconductor memory system of claim 1, wherein a data transmission unit of the first data input and output type is different from a data transmission unit of the second data input and output type.

6. The semiconductor memory system of claim 1, wherein the first non-volatile memory includes at least one of phase-change random access memory (PRAM), resistive random access memory (RRAM), magnetoresistive random access memory (MRAM), and ferroelectric random access memory (FRAM).

7. The semiconductor memory system of claim 1, wherein the first non-volatile memory stores data smaller in size and is more frequently accessed than the data stored in the second non-volatile memory.

8. The semiconductor memory system of claim 7, wherein the first non-volatile memory stores boot data used in the processor.

9. The semiconductor memory system of claim 7, wherein the first non-volatile memory stores system code used in the host device or application code executed in the host device.

10. The semiconductor memory system of claim 1, wherein the first non-volatile memory is used as a virtual memory of the host device.

11. The semiconductor memory system of claim 7, wherein the first non-volatile memory stores meta data of a file system used in the host device.

12. The semiconductor memory system of claim 1, wherein the second non-volatile memory includes a NAND flash memory.

13. The semiconductor memory system of claim 12, wherein the second non-volatile memory operates as at least one of a single-level cell flash memory and a multi-level cell flash memory.

14. The semiconductor memory system of claim 12, wherein the second non-volatile memory stores user data generated by a user.

15. The semiconductor memory system of claim 12, wherein the first non-volatile memory stores meta data mapping virtual addresses used in the processor to physical addresses of the second non-volatile memory.

16. A semiconductor memory device comprising:
a memory block including a first non-volatile memory allocated to a first region defined by a first address range within a range of physical addresses mapped to logical addresses of a storing region provided in an external processor, and a second non-volatile memory allocated in a second region defined by a second address range within the range of physical addresses, the second region being different from the first region; and
a memory transmission and reception unit for performing data input and output operations between the external processor and the first non-volatile memory using a first data input and output type, and for performing data input and output operations between the external processor and the second non-volatile memory using a second data input and output type,
wherein the first data input and output type comprises performing the data input and output operations between the processor and the first non-volatile memory by an access unit for the first non-volatile memory.

17. The semiconductor memory device of claim 16, wherein the second data input and output type comprises performing the data input and output operations between the processor and the second non-volatile memory by an access unit for the second non-volatile memory, which is different from the access unit for the first non-volatile memory.

18. The semiconductor memory device of claim 16, wherein a start address of the second address range is an address next to a finish address of the first address range.

19. A semiconductor memory device comprising:
a memory block including a first non-volatile memory configured to store data having first data characteristics and a second non-volatile memory configured to store data having second data characteristics different from the first data characteristics, the first and second non-volatile memories having difference ranges of physical addresses; and
a memory transmission and reception unit comprising a first transmission and reception unit configured for exchanging the data having the first data characteristics between a host device and the first non-volatile memory using a first data input and output type, and a second transmission and reception unit configured for exchanging the data having the second data characteristics between the host device and the second non-volatile memory using a second data input and output type, wherein the first data input output type comprises a direct access method.

20. The semiconductor memory device of claim 19, wherein the first non-volatile memory comprises one of phase-change random access memory (PRAM), resistive random-access memory (RRAM), ferroelectric random access memory (FRAM), and magnetoresistive random access memory (MRAM), and
wherein the second non-volatile memory comprises a flash memory.
